(19) United States
(12) Patent Application Publication
(10) Pub. No.: US 2010/0069134 A1
(43) Pub. Date: Mar. 18, 2010

(54) VARIANCE REDUCTION IN A SLOT MACHINE

(75) Inventors: MALCOLM DAVIS, DALLAS, TX (US); FREDRIK DAHL, LOERENSKOG (NO)

Correspondence Address: HOWISON & ARNOTT, L.L.P, P.O. BOX 741715, DALLAS, TX, 75374-1715, US

(73) Assignee: BRAIN GAMES, L.C., DALLAS, TX (US)

(21) Appl. No.: 12/558,995

(22) Filed: Sep. 14, 2009

Related U.S. Application Data
(60) Provisional application No. 61/097,445, filed on Sep. 16, 2008.

(51) Int. Cl. A63F 9/24; A63F 13/00

(52) U.S. Cl. 463/13; 463/30

(57) ABSTRACT

A method of operating an electronic gaming system includes receiving value from a human user of an electronic gaming machine, initiating a machine-implemented game on the electronic gaming machine, displaying indicia representative of a game state on a display, receiving input from the human user via a user interface associated with the electronic gaming machine, determining an outcome of the game, determining an estimate of the human user's probability of winning the game, the estimate having reduced variance compared to a simple average of the human user's outcomes, taking a set, predetermined action if the estimate is outside of the predetermined limits.

### CROSS-REFERENCE TO RELATED APPLICATIONS

This application claims benefit of U.S. Provisional Application for Patent Ser. No. 61/097,445, filed Sep. 16, 2008, and entitled VARIANCE REDUCTION IN A SLOT MACHINE, the specification of which is incorporated herein by reference in its entirety.

### TECHNICAL FIELD

This disclosure relates to casino gaming machines, and in particular to methods and apparatus for estimating the future success of a player, either human or machine, utilizing variance reduction techniques.

### BACKGROUND

As used herein the term “slot machine” or “game machine” is used to refer to automatic gaming machines of the type used in casinos. Such machines are typically designed to accept value from a human player in the in exchange for playing a game of chance. The value may be in the form of cash, game tokens, game tickets, a credit card or stored value card. After receiving the value, the game is played and the machine may dispense a prize, i.e. a “payout” depending on the result of the game.

Systems and methods for implementing various games on slot-type and/or video gaming machines are known. Interactive poker is one such game. Predicting the degree of success a given human player is likely to have when playing such games presents a significant challenge. Human players vary in their understanding of game strategies, probabilities and will have varying degrees of skill.

A given individual's skill at a game such as poker, implemented on a slot machine type game in a casino based environment may be estimated if the individual plays a sufficient number of times. However, poker is a game that behaves randomly and there are a large number of unknowns in the game, since there are a large number of cards that have not been turned over at many points in the game. The number of possible card combinations is enormous, not to mention the fact that erratic play and/or “bluffing” plays a major role in any poker scenario. Consequently, the number of games that would be required to estimate an individual's skill in the long run would be very large.

When a game such as poker is to be implemented in a machine in a casino-based environment, it is important that the game be a game of chance and not one of skill. If the game is one of skill, and is implemented on a slot machine or video type of device, i.e., placed on a casino floor, the human player is competing against the machine. If the machine adapts to the player's decision-making, then the game arguably becomes a game of skill and may not fall within the purview of many gaming commissions. Consequently, any machine-implemented game such as poker necessarily involves a large random component. The random component may be supplied with a random number generator used in connection with different aspects of the game. For example, in poker, a random number generator or pseudo-random number generator may be used to determine the order of cards in a simulated “deck” after a shuffle.

In some instances, it may be desirable for a casino or game owner to take one or more specific set actions, depending upon how competent a given individual may be at a game such as poker implemented on a slot machine. Individuals that play in a manner indicating that they will, in the long run, lose money may be provided with complimentary drinks, food or other items to encourage them to continue playing. The individual may also be provided credits for additional games to encourage him or her to continue playing. The odds on the machine may be changed to increase the chances of the individual winning so as to avoid discouraging the individual from further play.

Alternatively, if an individual plays in a fashion indicating that he or she may win or break even over the long run, it may be preferable to take a machine out of service or change the odds on the machine to prevent continuing losses. Thus, it would be desirable to have an estimate of how well the individual may play as soon as possible after he or she begins play. However, in the case of games such as machine-implemented poker, due to the large random component of the game, estimating a given individual's skill with any level of certainty would require the individual to play a very large number of hands. Thus, there exists a need for a system and method for generating an estimate of a human player's skill other than a simple average of the outcomes of games played by the human. The methods set forth herein utilize the mathematical method of control variates, which amounts to estimating the human player's luck in a given playing session, and deducting this estimated luck from the actual result. This gives a variance reduced result of the session, which will be a better predictor of future results than the player's actual result in the session.

### SUMMARY

In one aspect, a method of operating an electronic gaming system includes the steps of receiving value from a human user of an electronic gaming machine, initiating a machine-implemented game on the electronic gaming machine and displaying indicia representative of a game state on a display. For example, if the game is a machine-implemented poker game, the indicia may be representations of playing cards. Input is received from the human user via a user interface. In the case of a machine-implemented poker game, the input may be a decision to fold, check, raise or call. An outcome of the game is determined, and value may be dispensed to the human user based on predetermined criteria, (e.g. the human user has the best hand and wins the game).

An estimate of the human user's probability of success, i.e., the player's skill is determined, the estimate having reduced variance compared to a simple average of the human player's outcomes. For example a control variate, which corrects the actual result by deducting an estimate of the player's luck in the session, may be employed to generate the estimate. The estimate of the human user's success may then be compared to predetermined limits. If the estimate falls outside of the predetermined limits, a set action may be taken.

The set actions may be disabling or taking the electronic game machine out of service, changing the odds of winning or requiring the human user to input more value in order to continue play. The set actions may also include providing the human user with complimentary items such as food or drink or credits to play additional games.

In another aspect, an apparatus for playing an electronic machine-implemented game includes means for receiving value from a human user of the apparatus. The means may include a card reader, a currency counter, a ticket scanner or a device for receiving tokens. A display device is provided for displaying indicia representative of a game state. Means for receiving an input from the player in response to a display of indicia representing a game state is also provided. The input means may be a touch screen, buttons, levers and similar devices.

Means such as a cash dispenser, token or ticket dispenser or a device for incrementing the balance of a stored value card may be provided for dispensing value to the human user of the game machine based upon predetermined conditions, i.e., the human user wins the game. The apparatus includes a storage device for storing a game algorithm and an estimate algorithm for generating an estimate of the probability of a human player's success based upon the outcomes of a predetermined number of games played by the human player. A processor operative with the storage device is provided to implement the game algorithm and operative with the display device to display indicia representative of a game state. The processor is further operative to implement the estimate algorithm to generate an estimate of the probability of a player's success based on the outcome of previous game states, the estimate having reduced variability compared to an average of the player's outcomes in the game.

In one aspect, the machine-implemented game is poker, in which case the displayed indicia are visual representations of playing cards. In some embodiments, the processor is operative with preprogrammed instructions to take a set action based on an estimate of the probability of a player's success.

In another aspect, a method of operating an electronic gaming machine includes receiving value from a human user of the gaming machine, initiating a machine-implemented game on the electronic gaming machine and generating a game state with a game engine and displaying indicia representative of a game state. Input from the human user is received and possible outcomes of the game state are determined to calculate an average of the possible outcomes. The actual outcome of the game or game state is determined and an estimate of the human user's probability of success is determined using a control variate. The estimate has reduced variability compared to a simple average of the human user's outcomes in the game or through game states. If the human user's probability of success exceeds predetermined limits, a set action is taken. If the human user wins the game, value is dispensed to the human user. In one embodiment, the machine-implemented game is poker and the displayed indicia are private and community poker playing cards randomly selected from a standard 52-card deck.

In another embodiment, a machine-implemented system of operating a casino-style game includes a plurality of gaming machines operatively connected to a central processor. The gaming machines include means such as a keyboard or a graphical user interface to enable human users to interact with the machines to play a casino-style game. The gaming machines further include means to receive value from the human users such as currency receivers, card readers and similar devices. The gaming machines also include a display such as a CRT or LED screen for displaying indicia representative of a game state to the human users of the gaming machines.

In this embodiment, the gaming machines are operatively connected to a central processor configured to monitor game states for the plurality of gaming machines. In particular, the central processor is configured to determine possible outcomes of the game states of the machines in operation to determine an average of the possible outcomes of the games. The gaming machines receive inputs from the human users in response to the displayed indicia representative of a game and transmit game states to the central processor of analysis to determine a potential outcome of the game state. The central processor calculates an estimate of a human user's probability of success using a control variate and initiates a set action if the estimate falls outside of predetermined limits.

The use of a control variate reduces the variability of the estimate compared to a simple average of the human user's prior outcomes in the game. In one variation, the game provided by the system is a machine-implemented poker game wherein the displayed indicia are visual representations of a plurality of playing cards including private and community cards.

In yet another variation, a method of operating an electronic gaming system including a plurality of gaming machines includes the steps of:

a) receiving value from human users of the gaming machines;

b) initiating a machine-implemented game on the electronic gaming machines and determining a game state with a game engine wherein the game engine comprises a central processor operatively connected to the plurality of gaming machines;

c) displaying indicia representative of a game state to a human user of one of the plurality of gaming machines wherein the game state is communicated to the central processor by the gaming machine;

d) receiving an input from the human user in response to the displayed indicia;

e) calculating an estimate of the human user's probability of success using a control variate, the estimate having reduced variability compared to an average of the human user's prior outcomes in the game;

f) taking a set action if the estimate is greater than a predetermined value; and

g) dispensing value to the human user if the user wins the game.

### BRIEF DESCRIPTION OF THE DRAWINGS

For a more complete understanding, reference is now made to the following description taken in conjunction with the accompanying Drawings in which:

FIG. 1 is a schematic representation of a system utilizing variance reduction in a casino-style machine-implemented game;

FIG. 2 is a flowchart illustrating a method of reducing variance according to one embodiment of the invention;

FIG. 3 is a flowchart illustrating a method of implementing reducing variance according to one embodiment of the invention;

FIG. 4 illustrates an example of a simplified game of heads up Texas Hold'em;

FIG. 5 is a perspective view of a casino-type electronic game machine for implementing a game such as the game of FIG. 4;

FIG. 6 is a block diagram of a system for implementing a casino-style game using variance reduction;

FIG. 7 is flowchart illustrating an implementation of variance reduction in one embodiment;

FIG. 8 is a flowchart illustrating second implementation of variance reduction in a casino-type game; and

FIG. 9 is a block diagram of an alternate system for implementing a casino-style game using variance reduction.

### DETAILED DESCRIPTION

Referring now to the drawings, wherein like reference numbers are used herein to designate like elements throughout, the various views and embodiments of a slot machine type game with variance reduction are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

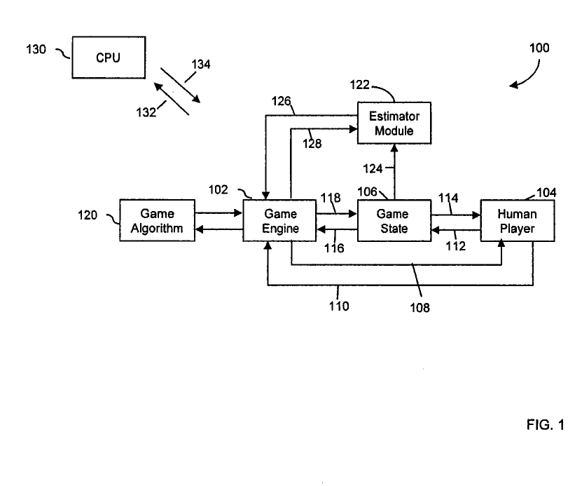

FIG. 1 is a block diagram schematically illustrating features of a machine-implemented game system 100. Typically, system 100 will be implemented as an electronic video game on a casino floor. System 100 includes a game engine 102 and the software, hardware and user interfaces necessary to play an interactive game with a human player 104. A game state represented by block 106 changes with the results of actions taken by the game engine 102 and human player 104. Actions by the game engine 102, represented by arrow 108 are displayed to human user 104. Actions by the human user 104, represented by arrow 110 are transmitted to game engine 102 with a human-interface such as a button, keypad, touch screen or similar device. In one embodiment, one or more systems 100 may be linked to a central computer or processor 130 with a data interface represented by arrows 132 and 134.

An action by human user 104 or by game engine 102, represented by arrows 112, 116, respectively, changes game state 106. Changes to game state 106, represented by arrows 114, 118 are displayed to the user and received by game engine 102. During the game, an action taken by game engine 102 may be determined with an algorithm 120 based on the different probabilities associated with the particular game state at that time. Such actions may include or be based on random factors to avoid repetitive responses to a particular game state 106 that could reveal a pattern that might be exploited by human player 104. Alternatively, actions taken by human player 104 may be based on the player's perception of the game state, his or her level of skill, the amount wagered, the amount of funds available to the player, his or her experiences with the game, his or her emotional state at the time and other factors.

Different humans may play a given game differently, using different strategies with varying degrees of success. Over many games, the skill or luck of a given player may be estimated. However, depending upon the degree of randomness inherent in the game and unpredictable human factors, there may be a high degree of variability associated with the player's success in the short term. To reduce the degree of variance and obtain an estimate of the player's luck or skill with a smaller sample size, e.g., fewer games played, a technique for generating an estimate with reduced variance may be employed.

In one embodiment, a variance reduction technique using control variates may be employed. The technique relies on the following principles. There is a random variable X, for which for which an estimate of the expected value E(X) (the long term average) is desired. A control variate V is a random variable that has positive correlation with X, and is known to have expected value zero: E(V)=0. This in turn is used to construct a modified outcome X′=X−V. Since X′ and X have the same expected value, E(X)=E(X′). The variance of X′, however, will typically be lower than that of X. If x1, x2, . . . , xn is a sequence of random draws of X, the standard estimate of E(X) is the sample average: (x1+x2+ . . . +xn)/n. With access to a control variate v, the estimate (x1−v1+x2−v2+ . . . +xn−vn)/n may be used.

Referring still to FIG. 1, in one embodiment, an estimator module or engine 122 may be used to estimate how lucky a particular game state 106 is for a player. Estimator module 122 receives game states 106 as indicated by arrow 124. Estimator module 122 also interfaces with game engine 102 as represented by arrows 126 and 128. After an action by human player 104 or game engine 102 results in a particular game state 106, a hypothetical game is played and finished for each possible outcome of the game state. The outcomes are denoted by Oi, where i is an index of the particular game state 106. The hypothetical games may be played by game engine 102 or a similar engine incorporated into estimator 122.

If O represents the outcome associated with a game state, an average value of O may be calculated to obtain the average of all possible outcomes O=(O1+O2+ . . . +Om)/m, where m is the number of possible outcomes. If the number of possible outcomes is too great to simulate, a large number, typically on the order of 1000, of hypothetical games may be played starting from game state 106 to estimate an average outcome.

If j is the index of the actual outcome, the “luck’ of the outcome is calculated as V=Oj−O. Since V has an expected value E(V)=0, and includes information on how lucky the particular game state is for a player, it is a valid control variate. The outcomes Oi may be evaluated according to how game engine 102 would play using algorithm 120 based on the particular game state. If human player 104 plays differently than game engine 102, it may make the variance reduction technique less effective, but it will not compromise the integrity of the method. The random variable V still has an expected value of zero.

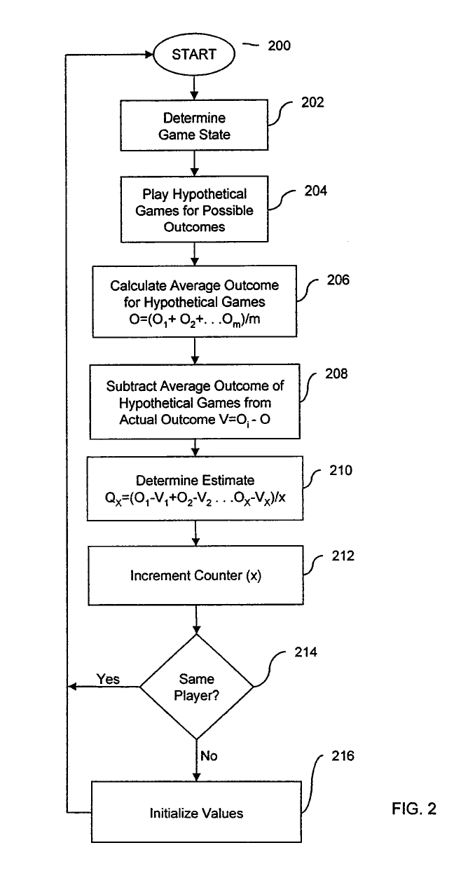

FIG. 2 is a flowchart illustrating a method of reducing variance according to one embodiment of the invention. Referring to FIGS. 1 and 2, the method begins at step 200 with an action by game engine 102 or player 104 that changes the game state 106. At step 202 estimator module 122 receives the actual game state 106. At step 204, hypothetical games are played for each possible outcome of game state 106 and all possible outcomes determined. The number of possible outcomes for a given game state 106 may depend upon the particular game and/or stage of play. An average outcome, (O=(O1+O2+ . . . +Om)/m), where m is the number of possible outcomes for the different possible game states, is calculated at step 206. Depending upon the particular game and the particular game state, the number of possible outcomes may be so great that it is not feasible to determine all possible outcomes. In this case, the average outcome O may be estimated by playing a large number of hypothetical games and averaging the outcomes. At step 208, the calculated average outcome O is subtracted from the actual outcome to obtain a control variate V (V=Oj−O). At step 210, an estimate Qx is determined as Qx=(O1−V1+O2−V2+ . . . Ox−Vx)/x, where x is the number of game states that the player has played.

At step 212, the value of x is incremented. At step 214, if the same player 104 continues playing, the process loops back to start at step 200. Alternatively, if the player 104 has changed, the values of O, V, Q and x are re-initialized at step 216, and the process loops back to start at step 200. As play continues, and player 104 goes through more game states, estimate Qx will provide an indication of how well or poorly the player is faring in the game. Since the variance of estimate Qx is less than the variance of the simple average of outcomes (O1+O2+ . . . +O×)/x, estimator Qx provides an estimate of how well or poorly the player will fare against the game with a greater degree of confidence than an estimate based on the simple average of the outcomes over the same number of plays.

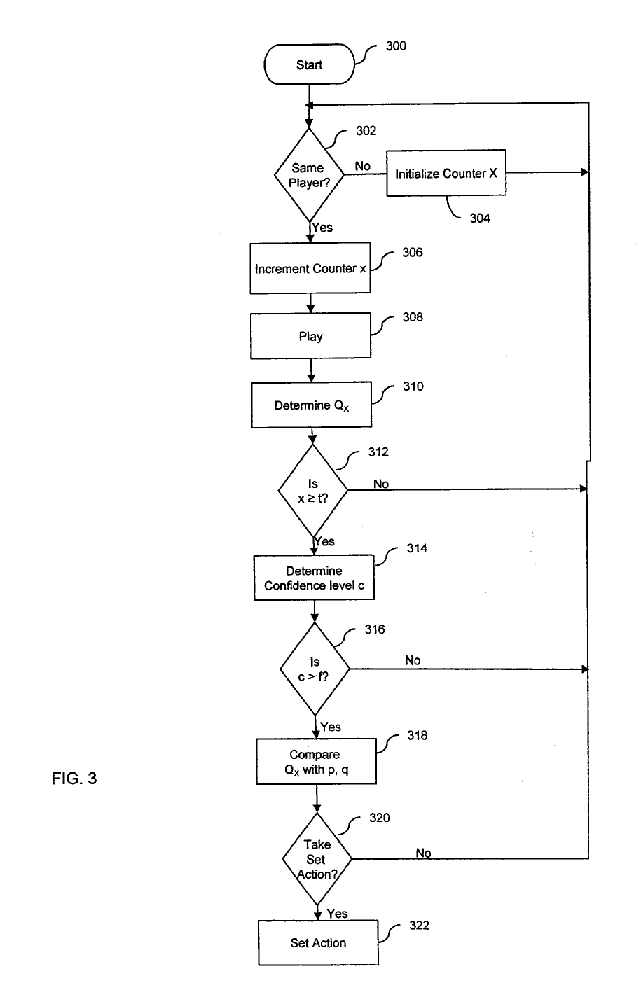

FIG. 3 is a flowchart illustrating a method of controlling a machine-implemented game using variance reduction. The method begins at step 300, where a human player initiates play on a game implemented in a system such as system 100 of FIG. 1. Typically, the game is initiated when the player inserts value into the machine. At step 302, a check is made to determine if the current player is the same as the previous player of the game. If not, a counter is initialized at step 304, and the process loops back. If the player is the same as the previous player, the counter is incremented at step 306 and the game is played at step 308. An estimator Qx of the player's luck and/or skill is determined for the player at step 310 as described in connection with FIG. 2. At step 312, the counter value x, i.e., the number of times the player has played, is compared to a predetermined value t. The value of t may be a predetermined number of completed games or the number of game states that the player has played through. If x is less than the predetermined value t, the program loops back to start at 300. This step permits a player to play some minimum number of games before a set action is taken as described below.

In one embodiment, a statistical confidence level c for estimate Qx may be determined at step 314 utilizing known techniques. The value of c will depend upon the number of games or games states that the player has played and the randomness of the outcomes. At step 316, the value of c may be compared to a predetermined value f. If c is less than f, the process loops back to start. This step requires a predetermined level of statistical confidence in estimator Qx before a set action is taken as described below. In other embodiments, step 314 and 316 may be omitted from the process.

At step 318, estimate Qx is compared to one or more predetermined threshold values p, q. Depending upon the difference between Qx and threshold values p, q, a determination of whether to take a set action may be made at step 320. For example, if the comparison indicates that the player's “luck” represented by Qx is below a predetermined threshold represented by p, the set action may be to encourage the player to continue play or prevent the player from becoming discouraged. For example, the player may be presented with complimentary items, such as drinks or food. In yet other embodiments, the player may be provided with tokens or a credit to allow him or her to continue play. Alternatively, if a player's “luck” represented by Qx is above a predetermined threshold represented by q, the set action may be to shut down the game machine and/or reset the odds of the game. If neither threshold value is reached, the process may loop back to start. Alternatively, if a threshold value p, q is reached, the set action may be taken at step 322.

It will be appreciated that criteria other than the estimate Qx of the player's luck may be considered in determining whether to take a set action at step 320. Such criteria may include the size of the player's wagers and how much the player has won or lost while playing the game. Previous set actions, such as providing the player with food, drinks, tokens, credits or coupons may also be considered.

While the system and method disclosed herein may be used with a wide variety of different machine-implemented games, for the purpose of illustration the method and apparatus will be described in connection with a type of poker referred to as “Hold'em.” In particular, the method and system may be realized in a heads-up limit game (i.e., two players with pre-specified bet and raise amounts) implemented on a casino-style game machine. A single game or hand consists of a number of rounds. In the first round, the machine (a player) and the human player are each dealt a fixed number, usually two, private cards. The private cards are not revealed to the opposing players. In subsequent rounds, some fixed number, (possibly zero), of shared public board cards are revealed.

Dealing and/or revealing of cards at different stages of the game is followed by betting. The betting involves alternating decisions, where each player can either check, fold, call, or raise. If a player folds, the hand ends and the other player wins the pot. If a player calls, he or she places an amount into the pot to match what the other player has already placed in the pot (possibly nothing). If a player raises, that player matches the other player's total and puts an additional fixed amount into the pot. Betting alternates until a player folds, ending the hand, or a player calls (as long as the call is not the first action of the round), continuing the hand to the next round.

There is a limit on the number of raises (or bets) per round, so the betting sequence has a finite length. If neither player folds before the final betting round is over, a showdown occurs. The players reveal their private cards and the player who can make the strongest poker hand with a combination of their private cards and the public board cards wins the pot.

The most common format for Hold'em poker is “Texas Hold'em,” which is used to determine the human world champion and is widely considered the most strategically complex variant. A standard 52-card deck is used and there are four betting rounds. In the first round, the players are dealt two private cards. In the second round (or flop), three board cards are revealed. In each of the third round (turn) and fourth round (river), a single board card is revealed. A fixed-bet maximum may be used, with fixed raise amounts of X units in the first two rounds and Y units in the final two rounds. Finally, blind bets are used to start the first round. The first player typically begins the hand with a set number of units in the pot and the second player with 2× the set number units.

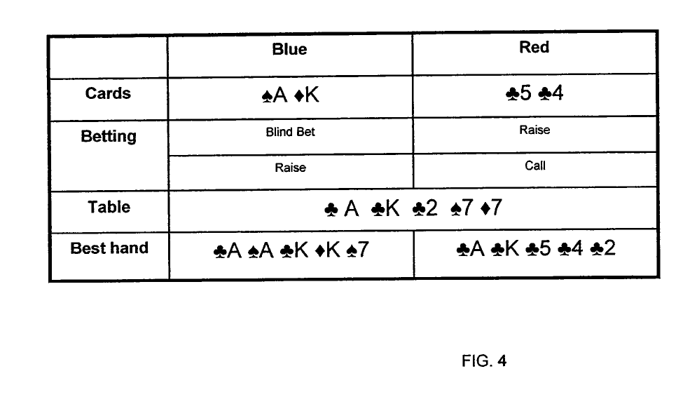

A simplified example game may proceed as shown in FIG. 4. In one embodiment, a full deck of 52 cards is shuffled (e.g. randomly arranged). Then two private cards are dealt to each player (hereafter designated Blue and Red). Blue then makes a forced blind bet of one unit, whereafter Red has the options of folding, calling and raising (by one unit). The betting process continues until one player folds or calls, except that Blue has the right to bet if Red calls the blind bet (the blind is “live”). Also, there is typically a limit of four raises, so the maximum pot size is limited.

As usual in poker, a player loses the pot to the opponent if he folds. If the betting stops with a call, five open cards, called the table, are dealt. These are common to the players, so that both players have seven cards from which they can choose their best five-card poker hand. The player that ends up with the better hand wins the pot. In the example game illustrated in FIG. 4, Red wins three units from Blue, because his flush beats Blue's two pair.

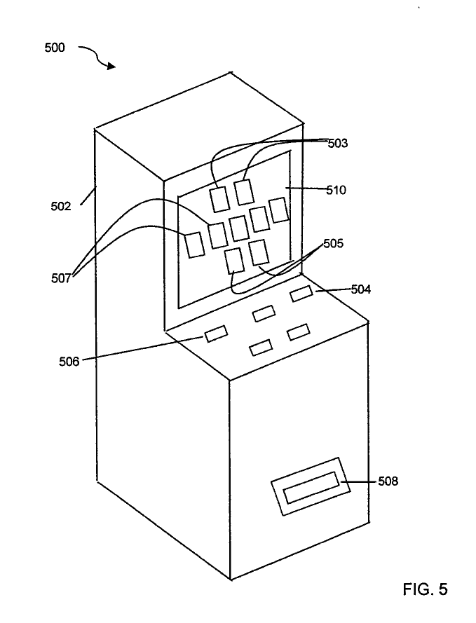

Referring now to FIG. 5, there is illustrated a diagrammatic view of a casino based gaming machine or system 500 wherein variance reduction may be used to predict the likelihood of success of a player. Machine 500 includes a chassis 502 having a user interface 504 that allows the user to interact with the system. User interface 504 may include features similar to a keyboard, buttons, a touch screen or similar devices that enables the user to play the game. The user input will typically be based on a decision to take an action. In the case of a machine-implemented poker game, the action may be to place a bet, raise, call/check or fold.

A payment input device 506 allows a user to input a credit card, debit card, smart card, bar coded ticket or other stored value card for maintaining a balance to draw from during play. Alternatively, payment input device 506 may be a currency reader. In one embodiment, system 500 may include a cash, ticket or token dispenser 508 to make cash payments or dispense tokens or tickets to the user. Typically, however, gaming systems use a stored value card that allows a player to move from game to game.

Machine 500 includes a display 510 that provides a human player an interface to the game, i.e., it displays a simulation of the cards in play. In accordance with a heads up Texas Hold'em machine-implemented game, the machine-implemented game, e.g. the first player, has access to two private cards 503 and the human, the second player, has access to two private cards 505. The human user's private cards will be displayed to the user, but the game itself has no access to those user's cards. The game's private cards will appear to the user on the display as if they are turned down, but the game will have access to the information associated therewith. The middle set of cards, i.e., the five community cards 507, are sequentially revealed during the flop, the turn and river stages of play. In one embodiment, game machine 500 has a dedicated engine or “brain” associated therewith. In this embodiment, game machine 500 is a stand-alone unit that may be monitored by a central processor for audit and accounting purposes. In other variations, one or more of game machines 500 may be controlled by a central processor to play the game.

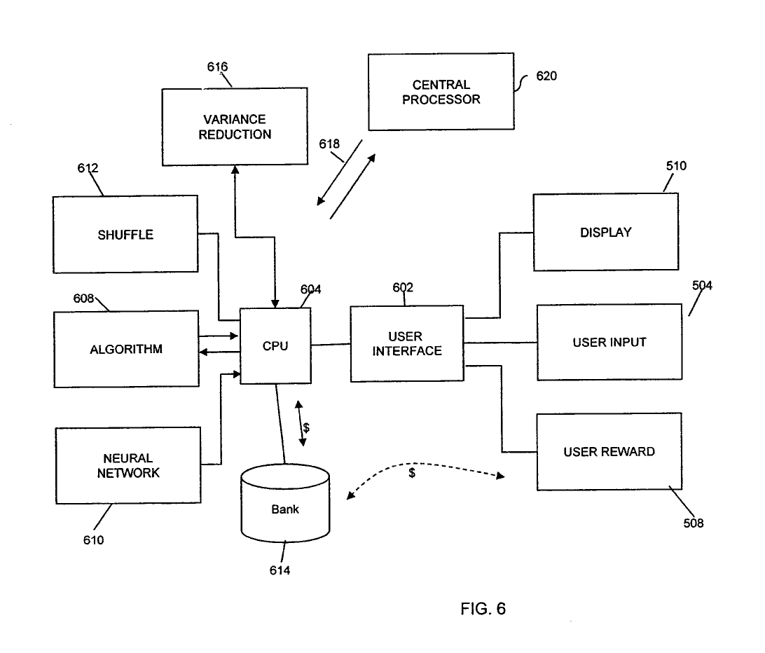

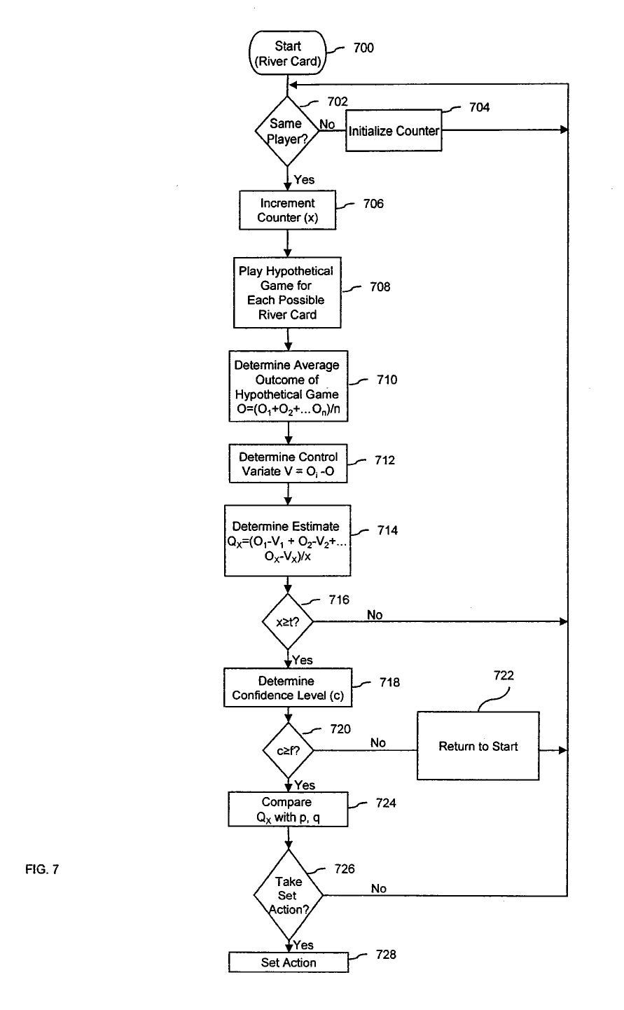

FIG. 6 is a block diagram schematically illustrating various features of machine 500. In one embodiment, display 510 and user interface 504 are connected through a data interface 602 to a processing unit 604. In one embodiment, processing unit 604 is a dedicated unit, configured with hardware and firmware exclusively to play the game. In one embodiment, one or more game machines 500 may include a data interface represented by arrows 618 with a central processor 620.

Processing unit 604 is operable to execute an algorithm 608 which plays the game. In one variation, processing unit 604 uses one or more neural networks 610 with algorithm 608. The output of neural networks 610 may be a probability distribution for certain actions, i.e., there are a number of actions associated with a neural network each of which have a probability distribution associated therewith. The neural networks may be “trained” to associate the probabilities of different outcomes based on particular game states. The probability distribution(s) may be used to determine actions that may be taken by the game during play, e.g. to fold, call/check or raise. Algorithm 608 may be designed to introduce a random component or factor in order to prevent predictable responses on the part of the game. In different embodiments, processor 604 may utilize one or more different algorithms to play the game.

Referring still to FIG. 6, the game will also have associated therewith some type of “shuffle” program 612 that will shuffle the cards. Shuffle program 612 may use a random or pseudo-random number generator to simulate a shuffle of a 52-card deck and select nine cards for the game. Two private cards will be “dealt” to the human player, two private cards will be “dealt” to the machine-implemented game along with the five community cards.

A bank module 614 is operable to disburse value to a user if the user meets certain predetermined requirements, i.e., he or she beats the game and/or wishes to terminate play with a positive balance. Bank module 614 may maintain a balance for the user, which may increase, or decrease depending upon the results of play between the game and the user. Depending on the results of play between the game and the user, value may be transferred back and forth between the user and bank 614. At one point, the user could have a negative balance and, at another point, the user may have a positive balance. Normally, however, the user will be required to maintain a positive balance during play. When the user decides to terminate play, if the balance is positive, value may be transferred to the user in the form of cash, tickets, tokens or by incrementing the value of a stored value card such as a debit card.

Also associated with the game is a variance reduction module 616. Module 616 may be utilized to determine an estimate of the luck or skill of a human player. As previously noted, the game described above has a large random component. Due to the high degree of variability, it would take very long sessions of play to estimate with any degree of certainty how well a human opponent would perform against a machine-implemented game, or vice versa. In order to speed the process, variance reduction may be utilized in connection with the game. In one embodiment, the procedure involves determining an estimate of the “objective luck” of the sequence of cards dealt to a human player.

FIG. 7 is a flowchart illustrating a method, in one embodiment, of utilizing variance reduction module 616 of FIG. 6 as a means of controlling the operation of a gaming system including a Texas Hold'em machine-implemented game. The process begins at step 700, when the last card for the round, (the river) is revealed. At step 702 a check is made to determine if the user playing the game has changed since the last game. In the case where a stored value card is used to play, this step may be accomplished by checking to see if the same stored value card is in use and/or if the stored value card has the same balance as in the previous game. In other embodiments, a timer may be used to determine if the time between games indicates that the user has changed. If a determination is made that the player has changed, a counter (x) is initialized at 704 and the process loops back to start.

If the player has not changed, at step 706, a counter (x) is incremented to record the number of games the player has played. At step 708 a hypothetical game is played for each possible river card with the outcome of each game designated as Oi, where i is an index of the river card. In one embodiment, O is a monetary value determined by wagers made during play. Upon completion of the hypothetical games, an average value of O may be calculated at step 710 as O=(O1+O2+ . . . +On)/n, where n is the number of possible river cards. In one embodiment, the hypothetical games may be played using processor 604 and algorithm 608 of FIG. 6. In other embodiments, the hypothetical games may be completed on a central processor.

In one embodiment, at step 712, the “luck” of the river card is calculated as V=Oj−O, where j is the index of the actual river card in the human's game. Since V has an expected value zero E(V)=0, and includes information on how lucky the river card was, it is a valid control variate. Next, at step 714, an estimate Qx of the player's luck is determined for the games that he or she has played as Qx=(O1−V1+O2−V2+ . . . Ox−Vx)/x. The number of games or hands x that the human player has played is compared to a predetermined value t at step 716. If the value of x is less than the predetermined value t, the process loops back to start. In one embodiment, t is selected to ensure that the human player has played a meaningful number of hands before taking a set action as described below.

In one embodiment, a statistical confidence level c for estimate Qx of the player's “luck” may be determined at step 718 utilizing known techniques. The value of c will depend upon the number of hands that the player has played and the randomness of the outcomes. At step 720, the value of c may be compared to a predetermined value f. If c is less than f, the process loops back to start at step 722. This step requires a predetermined level of statistical confidence in estimator Qx before a set action is taken as described below. In other embodiments, steps 718 and 720 may be omitted.

In one variation, estimate Qx may be compared to one or more predetermined threshold values p, q at step 724. Depending upon the difference between Qx and threshold values p, q a determination of whether to take a set action may be made at step 726. For example, if the comparison indicates that the player's “luck” represented by Qx is below a predetermined threshold represented by p, the set action may be to encourage the player to continue play. The player may be provided with complimentary food, drinks, game tokens or credits to encourage him or her to continue play. Alternatively, if a player's “luck” represented by Qx is above a predetermined threshold represented by q, the set action may be to shut down the game machine and/or reset the odds of the game. Other set actions may include decreasing the payout of the machine-implemented game, imposing a fixed or variable fee on users of the machine and similar actions. If neither threshold value is reached, the process may loop back to start. If a threshold value p, q is reached, the set action is taken at step 728. The set action may be implemented based on preprogrammed instructions or by the owner or operator of the electronic gaming machine.

Although the method described in connection with FIG. 7 is described in connection with the final card revealed in the game, i.e., the river card, the method may be implemented throughout the various stages of the game. For example, in the case of Texas “Hold'em” the process of estimating a player's “luck,” e.g., the probability of success, may be conducted after the initial deal based upon the player's private cards and then again after the flop, turn and river cards are disclosed or revealed.

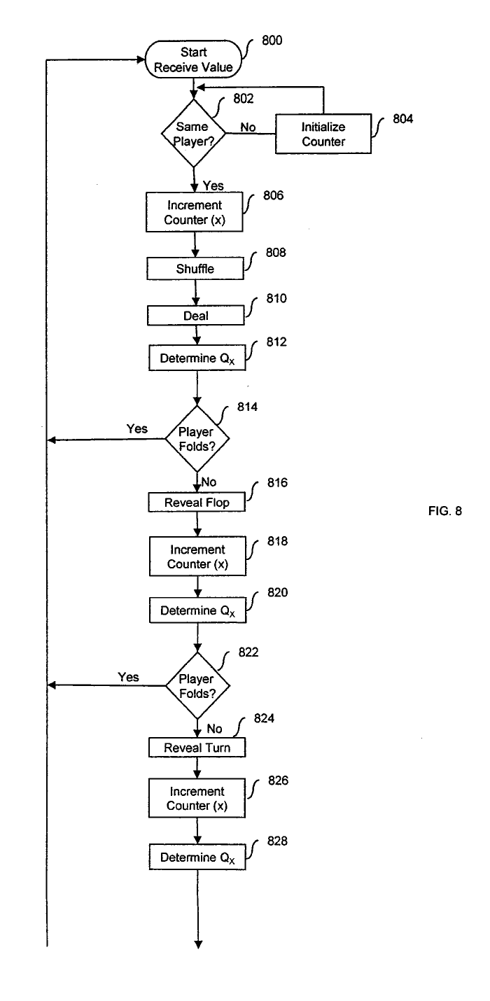

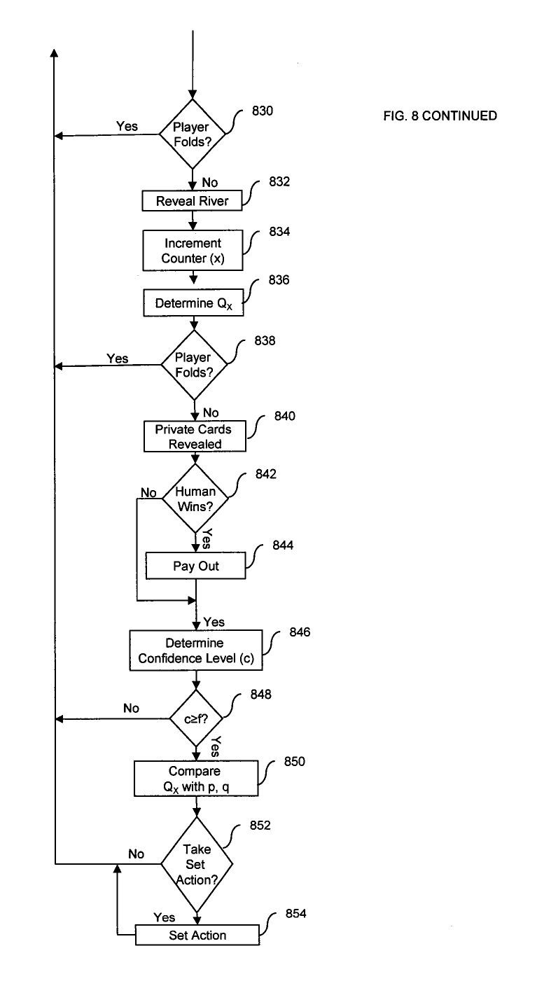

FIG. 8 is a flowchart illustrating a method, of utilizing variance reduction module 616 of FIG. 6 at different stages of a Texas Hold'em casino-style machine-implemented game. The method begins at step 800 where a human user of the machine enters value in order to initiate a game. At step 802, a check is made to determine if the human user playing the game has changed since the last game. In the case where a stored value card is used to play, this step may be accomplished by checking to see if the same stored value card is in use and/or if the stored value card has the same balance as in the previous game. In other embodiments, a timer may be used to determine if the time between games indicates that the user has changed. If a determination is made that the player has changed, a counter (x) is initialized at 804 and the process loops back. If the player has not changed, at step 806 the counter is incremented and a simulated “shuffle” of a 52 card deck is done at step 808. At step 810, nine cards are “dealt,” e.g., displayed on a video display. The nine cards include two private cards dealt to the player, two private cards dealt to the machine-implemented game along with 5 community cards. The human player's private cards are displayed face up; however, the machine-implemented game does not have access to these cards. The machine-implemented game's private cards are displayed face down. At this stage, the community cards are displayed face down. In other embodiments, the community cards may be sequentially displayed at the flop, turn and river stages of the game.

At step 812 a value of Qx is determined as previously described based on the human player's private cards. At step 814 either player (the machine or the human) may opt to bet, check or fold. If either player folds, the process loops back to step 800 and a new game may be initiated. Three community cards, i.e., the “flop” are revealed at step 816 and the counter (x) is incremented at step 818. The value of Qx is then recalculated based upon the human's player's private cards and the “flop” at step 820.

At step 822, either player has the option of betting, checking or folding. If either player folds, the process loops back to start at 800. Otherwise, play continues, and the “turn” card is revealed at step 824 and the counter (x) is incremented at step 826. The value of Qx is recalculated based on the human player's private cards along with the flop and river at step 828. At step 830, each player again has the option of betting, checking and folding. If either player elects to fold, the process loops back to start at 800. If play continues, the final community card, the “river” is revealed at step 832, the counter (x) is incremented at step 834 and Qx is recalculated at step 836.

At step 838 the final round of betting occurs and either player may bet, check or fold. If either player folds, the process loops back to start at 800. The private cards of the machine-implemented game and human player are revealed at step 840 and a winner is determined. If the human player wins at step 842, the machine makes a payout to the player at step 844. In either case, in one embodiment, at step 846 a statistical confidence level c for estimate Qx of the player's “luck” may be determined utilizing known techniques. At step 848, the value of c may be compared to a predetermined value f. If c is less than f, the process loops back to start. In other embodiments, the value of counter x may be compared to a predetermined number to determine if the human player has played through a meaningful number of games or game states.

If the value of c is greater than f, or if counter x is greater than a predetermined value, Qx may be compared to one or more predetermined threshold values p, q at step 850. Depending upon the difference between Qx and threshold values p, q, a determination of whether to take a set action may be made at step 852. For example, if the comparison indicates that the player's “luck” represented by Qx is below a predetermined threshold represented by p, the set action may be to encourage the player to continue play. The player may be provided with complimentary food, drinks, game tokens or credits to encourage him or her to continue play. If a player's “luck” represented by Qx is above a predetermined threshold represented by q, the set action may be to shut down the game machine and/or reset the odds of the game. Additional actions may include transmitting a message to the owner or operator of the machine to advise them of the situation. If neither threshold value is reached, the process may loop back to start. If a threshold value p, q is reached, the set action may be taken at step 854 after which the process loops back to start and a new game may be initiated.

It will be appreciated that the forgoing methods may be implemented in real-time or on an off-line, non-real time basis. For example, one or more players' responses to various game states or conditions may be stored in a database, either in the game machine or on a central processor connected to multiple game machines. Then, at a selected or predetermined time, the data reflecting the player or players' success may be processed.

In those cases where a player or players may be identified by means of a debit card, credit card, smart card, bar coded ticket or other stored value card, the individual player or players' performance may be analyzed. In other variations, where the player or players are not identified, the data may be analyzed to determine the performance of the game. Off-line processing of the data may be conducted at preselected intervals to evaluate the performance of the game so as to enable the game operator to take a set action if the game is not performing as anticipated.

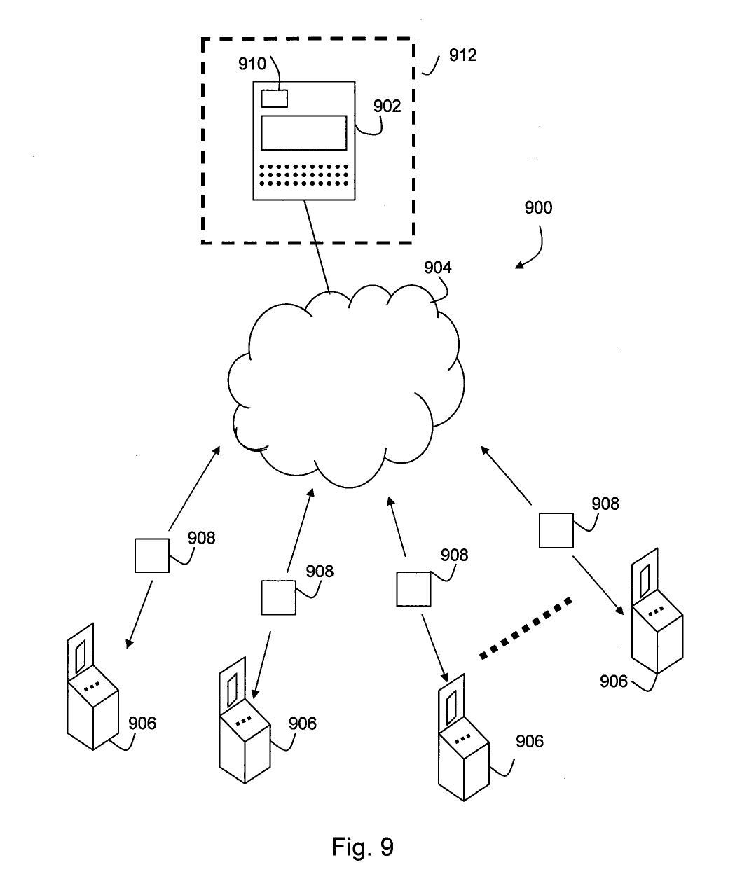

FIG. 9 is a block diagram illustrating an alternate system for use in casino-style gaming using variance reduction. System 900 includes a plurality of gaming machines 906 operatively connected to a dedicated variance reduction engine 902. In one embodiment, engine 902 may be a dedicated processor including hardware, firmware and software configured to implement the methods described above in connection with FIGS. 2, 3, 7 and 8. In one variation, engine 902 may employ one or more Application Specific Integrated Circuits 910 (ASICs) with specific instructions hard-wired or burned into non-volatile memory to implement the above-described methods. In some embodiments, engine 902 may include a combination of preprogrammed software along with firmware to implement the above-described methods. In yet other embodiments, engine 902 may be programmable using a remote device. One or more physical security measures generally indicated at 912 may be employed to maintain the integrity of engine 902 and to prevent tampering. Such measures may include locating engine 902 in a locked room or enclosure, and/or using alarms, motion detectors, proximity sensors or similar devices to prevent unauthorized access to engine 902.

Referring still to FIG. 9, engine 902 may be connected to gaming machines 906 via a network 904 and device interfaces 908. Interfaces 908 include hardware and software adequate to enable communications between engine 902 and machines 906. Network 904 may be a hard-wired or wireless Local Area Network (LAN), a Wide Area Network (WAN) or the Internet. Transmissions between engine 902 and gaming machines 906 may be encrypted using known techniques such as TSL or SSL protocols to prevent hacking or unauthorized access to the variance reduction engine 902 and gaming machines 906. In this embodiment, gaming machines 906 may be located at the same or different locations, for example gaming machines 906 may be located at different casinos, or similar establishments, at geographical diverse locations and operatively connected to engine 902 via a network as described above.

It will be appreciated by those skilled in the art having the benefit of this disclosure that the system and method of reducing variance in a casino-type slot machine provides a means of estimating a user's luck and taking set actions depending upon the estimate. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A method of operating an electronic gaming system comprising:
a) receiving value from a human user of an electronic gaming machine;
b) initiating a machine-implemented game on the electronic gaming machine;
c) displaying indicia representative of a game state on a display;
d) receiving input from the human user via a user interface associated with the electronic gaming machine;
e) determining an outcome of the game and dispensing value from the electronic gaming machine to the human user based on predetermined criteria;
f) determining an estimate of the human user's probability of winning the machine-implemented game, the estimate having reduced variance compared to a simple average of the human user's prior outcomes;
g) comparing the estimate to one or more predetermined limits; and
h) taking a set, predetermined action if the estimate is outside of the predetermined limits.

2. The method of claim 1 further comprising repeating steps b) through e) for a predetermined number of games before taking a set predetermined action.

3. The method of claim 1 wherein the machine-implemented game is poker.

4. The method of claim 1 wherein the displayed indicia are visual representations of playing cards.

5. The method of claim 1 wherein the set action is disabling the electronic gaming machine.

6. The method of claim 1 wherein the set action is reducing the amount of value dispensed to the human user of the electronic gaming machine.

7. The method of claim 1 wherein the set action is changing the probability of winning the game.

8. An apparatus for playing an electronic machine-implemented game comprising:
means for receiving value from a human user of the apparatus;
a display device for displaying indicia representative of a game state;
means for receiving an input from the user in response to a display of indicia representing a game state;
means for dispensing value to the human user of the game machine based upon predetermined conditions;
a storage device for storing a game algorithm and an estimate algorithm for generating an estimate of the probability of the human user's winning the game based upon the outcomes of a predetermined number of games played by the human user; and
a processor operative with the storage device to implement the game algorithm and operative with the display device to display indicia representative of a game state, the processor further operative to implement the estimate algorithm to generate an estimate of the probability of the human user's winning the game based on the outcome of previous game states, the estimate having reduced variability compared to an average of the user's outcomes in the game.

9. The apparatus of claim 8 wherein the machine-implemented game is poker.

10. The apparatus of claim 8 wherein the displayed indicia are visual representations of playing cards.

11. The apparatus of claim 8 wherein the processor is operative with preprogrammed instructions to take a set action based on an estimate of the probability of the human user winning.

12. The apparatus of claim 11 wherein the set action is disabling the electronic gaming machine.

13. The apparatus of claim 11 wherein the set action is reducing the amount of value dispensed to the human user of the electronic gaming machine.

14. The apparatus of claim 11 wherein the set action is changing the probability of winning the game.

15. A method of operating an electronic gaming machine comprising:
a) receiving value from a human user of the gaming machine;
b) initiating a machine-implemented game on the electronic gaming machine and generating a game state with a game engine;
c) displaying indicia representative of a game state;
d) determining possible outcomes of the game state to determine an average of the possible outcomes;
e) receiving an input from the human user in response to the displayed indicia;
f) determining an actual outcome of the game state;
g) calculating an estimate of the human user's probability of success using a control variate, the estimate having reduced variability compared to an average of the human user's outcomes in the game;
h) taking a set action if the estimate is greater than a predetermined value; and
i) dispensing value to the human user if the user wins the game.

16. The method of claim 15 wherein the machine-implemented game is poker.

17. The method of claim 15 wherein the displayed indicia are visual representations of a plurality of playing cards including private and community cards.

18. The method of claim 15 wherein the set action is disabling the electronic gaming machine.

19. The method of claim 15 wherein the set action is changing the probability of success of the human user.

20. A machine-implemented system of operating a casino-style game comprising:
a plurality of gaming machines, the gaming machines including means for human users to play a game and means to receive value from the human users of the gaming machines, the gaming machines including a display for displaying indicia representative of a game state to the human users of the gaming machines:
a central processor operatively connected to the plurality of gaming machines and configured to monitor game states for the plurality of gaming machines, the processor configured to determine possible outcomes of the game state to determine an average of the possible outcomes of the game; and
wherein the gaming machines receive inputs from the human users in response to the displayed indicia, transmits changes in the game state to the central processor, the central processor determining a potential outcome of the game state, and wherein the central processor calculates an estimate of a human user's probability of success using a control variate.

21. The system of claim 20 wherein the estimate of a human user's probability of success has reduced variability compared to an average of the human user's prior outcomes in the game.

22. The system of claim 20 wherein the central processor is configured to direct a set action if the estimate of the human user's probability of success is greater than a predetermined value; and
wherein the gaming machines are configured to dispense value to human users winning the game.

23. The system of claim 20 wherein the machine-implemented game is poker and wherein the displayed indicia are visual representations of a plurality of playing cards including private and community cards.

24. A method of operating an electronic gaming system including a plurality of gaming machines comprising:
a) receiving value from a human user of one of the plurality of gaming machines;
b) initiating a machine-implemented game on the electronic gaming machine and generating a game state with a game engine, wherein the game engine comprises a central processor operatively connected to the plurality of gaming machines;
c) displaying indicia representative of a game state to a human user of one of the plurality of gaming machines wherein the game state is communicated to the central processor by the gaming machine;
d) receiving an input from the human user in response to the displayed indicia;
e) determining an estimate of the human user's probability of success using a control variate, the estimate having reduced variability compared to an average of the human user's prior outcomes in the game;
f) taking a set action if the estimate is greater than a predetermined value; and
g) dispensing value to the human user if the human user wins the game.

25. The method of claim 24 wherein the machine-implemented game is poker.

26. The method of claim 24 wherein the displayed indicia are visual representations of a plurality of playing cards including private and community cards.
